(19) United States
(12) Patent Application Publication
(10) Pub. No.: US 2025/0021644 A1
(43) Pub. Date: Jan. 16, 2025

(54) PREPARING READ-FOLLOWED-BY-WRITE INDICATOR BASED ON READ AND WRITE SEQUENCES

(71) Applicant: Dell Products L.P., Round Rock, TX (US)

(72) Inventors: Shaul Dar, Petach Tikva (IL); Ramakanth Kanagovi, Telangana (IN); Guhesh Swaminathan, Chennai (IN); Rajan Kumar, Bihar (IN)

(21) Appl. No.: 18/352,364

(22) Filed: Jul. 14, 2023

(51) Int. Cl. G06F 21/55

(52) U.S. Cl. CPC G06F 21/554; G06F 21/552

(57) ABSTRACT

A technique of preparing a read-followed-by-write indicator for detecting ransomware attacks includes tracking mirror I/Os as sequences of reads and sequences of writes. The technique includes recording compact representations of read-request sequences and matching at least some of the read-request sequences with corresponding write-request sequences that arrive later. A ransomware indicator for tracking mirror I/Os may then be provided based at least in part on the matching sequences.

### BACKGROUND

Data storage systems are arrangements of hardware and software in which storage processors are coupled to arrays of non-volatile storage devices, such as magnetic disk drives, electronic flash drives, and/or optical drives. The storage processors, also referred to herein as “nodes,” provide service for storage requests arriving from host machines (“hosts”), which specify blocks, files, and/or other data elements to be written, read, created, deleted, and so forth. Software running on the nodes manages incoming storage requests and performs various data processing tasks to organize and secure the data elements on the non-volatile storage devices.

A regrettable fact of modern technology is that computers can become the targets of ransomware attacks. For example, a ransomware script may infiltrate a host machine and attempt to encrypt files or portions of files backed by a data storage system. The resulting encryption renders the files unreadable. A ransom note may be left on an infected host, and substantial sums of money may be demanded in exchange for a key that can decrypt the data. As ransomware software can contain errors, even paying for the key provides no guarantee that the data can be fully recovered.

Various solutions have been proposed for detecting ransomware attacks in progress. One solution generates attributes of data blocks being written and/or read in a storage system and applies those attributes to a model for determining whether a ransomware attack is likely to be occurring. A particularly useful attribute is the number or percentage of reads to a data object followed by writes to the same locations of that data object. The power of this attribute reflects the modus operandi of the ransomware attacker—to read data, encrypt the data, and write the data back to where it was found.

### SUMMARY

Unfortunately, tracking reads-followed-by-writes (also referred to herein as “mirror I/Os” or “overwrites”) is extremely costly in terms of memory. Any read request received by a storage system can be considered a candidate for a mirror I/O, as it may eventually be followed by a corresponding write request to the same location. Thus, tracking mirror I/O has entailed creating records for huge numbers of read requests and holding those records for potentially long periods of time, in order that some fraction of the read requests might be matched with later-arriving write requests. In-memory data structures for tracking mirror I/O can grow to several GB in size, requiring storage systems to use large amounts of memory and potentially displacing memory that could be used for other critical tasks. The large data structures can also become unwieldy to search and manage, impairing system performance. What is needed, therefore, is a more efficient way of tracking mirror I/O, so that ransomware detection can benefit from the advantages of the read-followed-by-write indicator without suffering the large costs of providing this indicator in terms of memory and performance.

To address the above need at least in part, an improved technique of preparing a read-followed-by-write indicator for detecting ransomware attacks includes tracking mirror I/Os as sequences of reads and sequences of writes. The technique includes recording compact representations of read-request sequences and matching at least some of the read-request sequences with corresponding write-request sequences that arrive later. A ransomware indicator for tracking mirror I/Os may then be provided based at least in part on the matching sequences. Advantageously, the improved technique can be realized with much less memory and lesser performance impacts than the prior approach.

Certain embodiments are directed to a method of preparing a read-followed-by-write indicator for detecting suspected ransomware attacks in a storage system. The method includes receiving I/O requests by the storage system, the I/O requests including a read-request sequence, the read-request sequence including multiple consecutive read I/O requests directed to consecutive storage locations. The method further includes storing a compact representation of the read-request sequence in a data structure, the compact representation indicating a beginning of the read-request sequence and an end of the read-request sequence. The method still further includes updating the read-followed-by write indicator based at least in part on matching the compact representation of the read-request sequence in the data structure with a write-request sequence received in the I/O requests after the read-request sequence and having a beginning and an end that correspond respectively to the beginning and the end of the read-request sequence.

Other embodiments are directed to a computerized apparatus constructed and arranged to perform a method of preparing a read-followed-by-write indicator, such as the method described above. Still other embodiments are directed to a computer program product. The computer program product stores instructions which, when executed on control circuitry of a computerized apparatus, cause the computerized apparatus to perform a method of preparing a read-followed-by-write indicator, such as the method described above.

The foregoing summary is presented for illustrative purposes to assist the reader in readily grasping example features presented herein; however, this summary is not intended to set forth required elements or to limit embodiments hereof in any way. One should appreciate that the above-described features can be combined in any manner that makes technological sense, and that all such combinations are intended to be disclosed herein, regardless of whether such combinations are identified explicitly or not.

### BRIEF DESCRIPTION OF THE SEVERAL VIEWS OF THE DRAWINGS

The foregoing and other features and advantages will be apparent from the following description of particular embodiments, as illustrated in the accompanying drawings, in which like reference characters refer to the same or similar parts throughout the different views.

FIG. 1 is a block diagram of an example environment in which embodiments of the improved technique can be practiced.

FIG. 2 is a block diagram showing an example read-request sequence followed by a corresponding write-request sequence.

FIG. 3 is a block diagram of an example trace memory of FIG. 1 in additional detail.

FIG. 4 is a block diagram showing an example compact representation of a read-request sequence.

FIG. 5 is a block diagram showing an example compact representation of a write-request sequence.

FIG. 6a is a block diagram showing a compact read-request representation, populated with values for representing an initial read-request sequence.

FIG. 6b is a block diagram showing the compact read-request representation of FIG. 6a, with updated values indicating a continuation of the sequence depicted in FIG. 6a.

FIG. 6c is a block diagram showing a compact write-request representation of FIG. 4, populated with values that indicate a match to the read-request sequence depicted in FIG. 6b.

FIG. 7 is a flowchart showing an example method of managing a size of the sequence data structure of FIG. 1 by deleting sequences based on age.

FIG. 8 is a flowchart showing an example method of managing the size of the sequence data structure of FIG. 1 by deleting sequences based on the arrival of intervening I/O requests.

FIG. 9 is a flowchart showing an example method of preparing a read-followed-by write indicator for detecting suspected ransomware attacks in a storage system.

FIG. 10 is a graph showing various indicators of ransomware attacks ranked by importance for the purpose of binary classification.

FIGS. 11a and 11b are graphs showing various indicators of ransomware attacks ranked by importance for the purpose of binary classification (FIG. 11a) and multi-class classification (FIG. 11b).

FIGS. 12a and 12b are graphs showing the importance of the read-followed-by-write indicator for binary classification (FIG. 12a) and multi-class classification (FIG. 12b), looking at both read-followed-by-write tracking based on individual I/Os and read-followed-by-write tracking based on sequences.

### DETAILED DESCRIPTION

Embodiments of the improved technique will now be described. One should appreciate that such embodiments are provided by way of example to illustrate certain features and principles but are not intended to be limiting.

An improved technique of preparing a read-followed-by-write indicator for detecting ransomware attacks includes tracking mirror I/Os as sequences of reads and sequences of writes. The technique includes recording compact representations of read-request sequences and matching at least some of the read-request sequences with corresponding write-request sequences that arrive later. A ransomware indicator for tracking mirror I/Os may then be provided based at least in part on the matching sequences.

Our work has shown that reads and writes initiated by ransomware during ransomware attacks almost always occur in sequences of consecutive reads followed by consecutive writes, rather than as random reads and writes. Also, we have observed that sequences of I/O requests can be stored more compactly than individual I/O requests. The improved technique leverages both of these factors by tracking sequences of read requests in a data structure using compact representations and attempting to match those compact representations of read sequences to subsequent write sequences. Given that nearly all reads and writes performed by ransomware occur in sequences, a sequence-based indicator of reads-followed-by writes is substantially just as effective as one based on individual I/O reads and writes but can be achieved at a small fraction of the cost in terms of memory and performance.

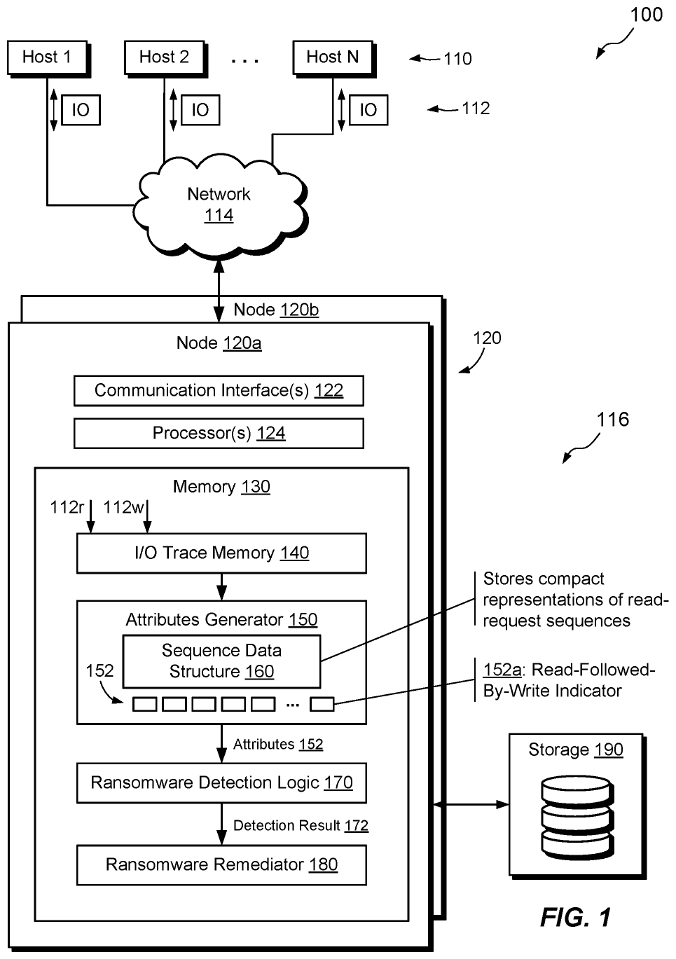

FIG. 1 shows an example environment 100 in which embodiments of the improved technique can be practiced. Here, multiple hosts 110 are configured to access a data storage system 116 over a network 114. The data storage system 116 includes one or more nodes 120 (e.g., node 120a and node 120b), and storage 190, such as magnetic disk drives, electronic flash drives, and/or the like. Nodes 120 may be provided as circuit board assemblies or blades, which plug into a chassis (not shown) that encloses and cools the nodes. The chassis has a backplane or midplane for interconnecting the nodes 120, and additional connections may be made among nodes 120 using cables. In some examples, the nodes 120 are part of a storage cluster, such as one which contains any number of storage appliances, where each appliance includes a pair of nodes 120 connected to shared storage. In some arrangements, a host application runs directly on the nodes 120, such that separate host machines 110 need not be present. No particular hardware configuration is required, however, as any number of nodes 120 may be provided, including a single node, in any arrangement, and the node or nodes 120 can be any type or types of computing device capable of running software and processing host I/O's.

The network 114 may be any type of network or combination of networks, such as a storage area network (SAN), a local area network (LAN), a wide area network (WAN), the Internet, and/or some other type of network or combination of networks, for example. In cases where hosts 110 are provided, such hosts 110 may connect to the node 120 using various technologies, such as Fibre Channel, iSCSI (Internet small computer system interface), NVMeOF (Nonvolatile Memory Express (NVMe) over Fabrics), NFS (network file system), and CIFS (common Internet file system), for example. As is known, Fibre Channel, iSCSI, and NVMeOF are block-based protocols, whereas NFS and CIFS are file-based protocols. The node 120 is configured to receive I/O requests 112 according to block-based and/or file-based protocols and to respond to such I/O requests 112 by reading or writing the storage 190.

The depiction of node 120a is intended to be representative of all nodes 120. As shown, node 120a includes one or more communication interfaces 122, a set of processors 124, and memory 130. The communication interfaces 122 include, for example, SCSI target adapters and/or network interface adapters for converting electronic and/or optical signals received over the network 114 to electronic form for use by the node 120a. The set of processors 124 includes one or more processing chips and/or assemblies, such as numerous multi-core CPUs (central processing units). The memory 130 includes both volatile memory, e.g., RAM (Random Access Memory), and non-volatile memory, such as one or more ROMs (Read-Only Memories), disk drives, solid state drives, and the like. The set of processors 124 and the memory 130 together form control circuitry, which is constructed and arranged to carry out various methods and functions as described herein. Also, the memory 130 includes a variety of software constructs realized in the form of executable instructions. When the executable instructions are run by the set of processors 124, the set of processors 124 is made to carry out the operations of the software constructs. Although certain software constructs are specifically shown and described, it is understood that the memory 130 typically includes many other software components, which are not shown, such as an operating system, various applications, processes, and daemons.

As further shown in FIG. 1, the memory 130 “includes,” i.e., realizes by data and execution of software instructions, an I/O trace memory 140, an attributes generator 150, ransomware detection logic 170, and a ransomware remediator 180. The I/O trace memory 140 is configured to store information about I/O requests 112 received by the node 120a, such as read I/O requests 112r, write I/O requests 112w, and other types of I/O requests. In an example, the I/O trace memory 140 provides an in-memory log of recently-received I/O requests and various information about them.

The attributes generator 150 is configured to generate attributes 152 of I/O requests 112. The attributes may be based on analysis of recent I/O requests 112 logged in the trace memory 140 and may be useful in determining whether a ransomware attack is likely to be occurring. Many attributes 152 are typically produced. One particularly strong attribute is a read-followed-by-write indicator 152a, which provides a count or percentage of read I/O requests 112r that are followed by write I/O requests 112w to the same locations, i.e., mirror I/Os. Storage systems experiencing ransomware attacks tend to have high values of the read-followed-by-write indicator 152a, which should be no surprise given that the operation of ransomware is to read data, encrypt the data, and write the data back to where it was found.

The ransomware detection logic 170 is configured to receive the attributes 152 (including the read-followed-by-write indicator 152a) and to make a determination, based on the attributes 152, of whether a ransomware attack is likely to be occurring. In an example, the ransomware detection logic 170 is configured to operate on newly-generated attributes 152 on a repeating basis, such as once every few seconds, once every few minutes, or the like, which can vary based on system activity. The ransomware detection logic 170 may be implemented in a variety of ways, such as with circuitry for computing weighted sums of attributes, combinatorial logic, fuzzy logic, or machine-learning classification. A random-forest machine-learning classification algorithm is particularly well suited to this task, given its generality, simplicity, tunability, and ability to cope with over-fitting. In an example, each operation of the ransomware detection logic 170 produces a detection result 172, which may be a binary result that indicates whether a ransomware attack is suspected. Alternatively, the detection result 172 may be a multi-class result, which indicates not only whether a ransomware attack is suspected, but also the specific type of ransomware attack that is suspected. Example types of ransomware attacks include but are not limited to TeslaCrypt, Cerber, WannaCry, GandCrab4, Ryuk, Sodinokibi, and Darkside.

The ransomware remediator 180 is configured to take remedial action in response to a positive detection result 172. Examples of remedial action include issuing an alert to a system administrator, throttling or blocking I/O requests 112 to an affected data object (e.g., volume, LUN, sub-LUN, partition, etc.), taking a snapshot of the affected data object, and/or disconnecting a host 110 determined to be the source of the attack. Remedial actions can be diverse. Those mentioned are provided merely as examples, which are not intended to be limiting.

As further shown in FIG. 1, the attributes generator 150 includes or otherwise has access to a sequence data structure 160. In previous implementations, a different data structure was used for tracking mirror I/Os as individual reads and writes. That data structure grew to be exceedingly large and difficult to manage. In accordance with improvements hereof, the sequence data structure 160 tracks sequences of reads and sequences of writes using compact representations, which results in tremendous memory savings (typically greater than an order of magnitude).

The sequence data structure 160 may be implemented in a variety of ways. In some examples, the sequence data structure 160 is provided as a hash table, which provides fast lookups for sequences based on a hash key, which may be computed based on start LBA (logical block address) of a sequence. Thus, for example, any sequence may be found by hashing its start LBA and performing a key-value search of the sequence data structure 160 using the hashed start LBA as the key. In other examples, the sequence data structure 160 may be implemented using a tree structure, such as an AVL (Adelson-Velsky and Landis) tree. In some examples, the sequence data structure 160 may be searchable based on end LBA, i.e., the location where a sequence ends, in addition to start LBA. In some examples, the data structure 160 may have different regions dedicated to respective data objects, such as respective volumes. In this example, any search results based on a search of a portion of the data structure may be limited to results for a particular volume. One should appreciate that the sequence data structure 160 may be formed and managed using any number of software objects. Thus, the use of the term “data structure” is not intended to imply a single software object but rather to include any number of software objects that are used together to provide the described functionality.

In example operation, the hosts 110 issue I/O requests 112 to the data storage system 116. The node 120a receives the I/O requests 112 at the communication interfaces 122 and initiates further processing. Such processing may involve returning requested data in response to read requests 112r and writing specified data in response to write requests 112w. Such processing may further include logging information about the I/O requests 112 in the I/O trace memory 140.

As I/O requests 112 are being logged in the I/O trace memory 140, the attributes generator 150 generates attributes 152 based on the logged I/O requests 112. Generating certain attributes may be complex. For example, generating the read-followed-by-write attribute 152a involves creating and storing compact representations of read sequences in the data structure 160 and attempting to match at least some of the read sequences with write sequences that arrive later. For example, when a new write sequence is received, the attributes generator 150 may perform a lookup for a matching read sequence in the data structure 160 based on start LBA. If a read sequence is found with the same start LBA, the attributes generator 150 determines whether the end LBA of the write sequence matches the end LBA of the matched read sequence. If so, a match is confirmed. It should be noted that candidates for matching may be limited to particular data objects, such as volumes.

In an example, the read-followed-by-write attribute 152a develops over time. Whenever a match is detected between a read sequence and a subsequent write sequence, the read-followed-by-write attribute 152a may be updated, e.g., based on the number of I/O requests in the matching sequences. For example, if a pair of matching sequences contains four reads followed by four writes, then a factor used in determining the read-followed-by-write attribute 152a may be increased by eight. The “factor” may be increased rather than the attribute 152a itself as the read-followed-by-write attribute 152a may be expressed as a percentage, such as a percentage of I/O operations that are parts of a mirror I/O, rather than as a raw number of mirror I/Os. In an example, the read-followed-by-write attribute 152a may be computed for a current cycle as follows:

$$\frac{Total \# IO requests ( reads and writes ) that belong to matching sequences}{100 * Total IO requests ( reads and writes ) received}$$

Increasing the read-followed-by-write attribute 152a based on the number of I/O requests in matching sequences provides a helpful weighting of matches, by increasing the indicator 152a more for longer sequences than for shorter sequences.

After some period of time, the attributes generator 150 may complete a current cycle and provide the generated attributes 152 to the ransomware detection logic 170, e.g., as a single row of input data. The ransomware detection logic 170 then generates a detection result 172. If the result is positive, the ransomware remediator 180 may act to limit the effect of the suspected attack, e.g., in any of the ways described above.

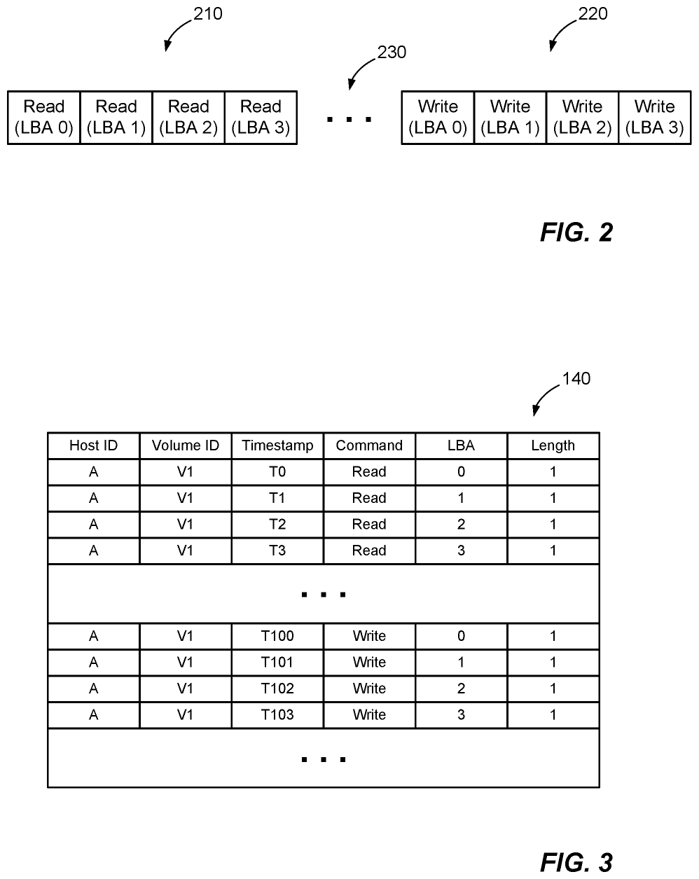

FIG. 2 shows an example of read and write sequences that may be received by the node 120a as part of a ransomware attack. Here, a sequence 210 of reads is followed by a sequence 220 of writes. The sequence of reads includes multiple read requests 112r received consecutively in time and directed to consecutive LBAs. For example, a read of LBA 0 arrives first, followed by a read of LBA 1, then a read of LBA 2, and then a read of LBA 3.

A corresponding sequence 220 of write requests arrives after the sequence 210 of read requests, i.e., following a timing gap 230. The sequence 220 of write requests includes multiple write requests 112w received consecutively in time and directed to consecutive LBAs. Here, the LBA range of the write sequence 220 matches the LBA range of the read sequence 210 and occurs later. The example therefore depicts a read-followed-by write sequence.

This simple example assumes that each read and write is directed to a single block. Reads and writes may be of any length, however. Formally, a sequential read may be defined as a pair of read requests such that the second read request begins were the first one ended, i.e., the LBA of the second read request is the sum of the LBA of the first read request plus the number of bytes read by the first LBA request. We define a sequential write similarly for a pair of write requests. Thus, sequences of read requests comprise consecutive pairs of sequential reads, and sequences of write requests comprise consecutive pairs of sequential writes.

One should appreciate that the node 120a typically receives many I/O requests, which may be directed to many data objects. Thus, sequential reads or writes need not occupy consecutive locations of the I/O trace memory 140, as many I/O requests are directed to other objects and arrive in the times between consecutive I/Os in the sequence. Accordingly, sequences 210 and 220 may be defined in relation to particular data objects, such as volumes. Thus, for example, the read requests in sequence 210 are consecutive for a particular volume, but not for the storage system as a whole. Likewise, the write requests in sequence 220 are consecutive for the same volume.

The gap 230 between the read and write sequences may vary in length. Tables 1 and 2 below show details of example sequence statistics for ransomware and benign activity, respectively. In the ransomware case, mirror I/Os occur in sequences ranging in length from 2 to 125, with the long tail reaching much higher. The average sequence length in our experiments was 91. Longer sequences are generally associated with longer gaps 230 between the read and write sequences (22 seconds for the 90% quantile). In the case of benign activity, where the likelihood of mirror I/Os is much lower, the sequences are shorter, with an average length of 13, and the gap 230 between the reads and writes is much lower, typically less than 0.01 second.

TABLE 1
Ransomware Sequence Statistics

| | Sequence | Read-Read Time | Read-Write Time |
|---|---|---|---|
| Quantile | Length | Difference (sec) | Difference (sec) |
| 5% | 2 | 0 | 0.03 |
| 10% | 2 | 0 | 0.91 |
| 25% | 3 | 0 | 7 |
| 50% | 7 | 0.00012 | 11 |
| 75% | 25 | 0.00055 | 15 |
| 90% | 125 | 0.94 | 22 |
| Max | 34280 | 367 | 389 |
| Mean | 91.3 | 2.7 | 12 |

TABLE 2
Benign Sequence Statistics

| | Sequence | Read-Read Time | Read-Write Time |
|---|---|---|---|
| Quantile | Length | Difference (sec) | Difference (sec) |
| 5% | 4 | 0 | 0.00011 |
| 10% | 8 | 0.00000023 | 0.0002 |
| 25% | 8 | 0.00000024 | 0.00047 |
| 50% | 8 | 0.00000046 | 0.0011 |
| 75% | 8 | 0.00000047 | 0.0027 |
| 90% | 8 | 0.00000119 | 0.0072 |
| Max | 16384 | 181 | 223 |
| Mean | 12.8 | 0.20 | 1.2 |

FIG. 3 shows an example arrangement of the I/O trace memory 140. Here, the following information may be collected for each I/O request 112 received:
Host ID: an identifier of the host 110 that initiated the I/O request.
Volume ID: an identifier of the particular volume to which the I/O request was directed:
Timestamp: a time of receipt of the I/O request by the node 120a.
Command: The nature of the I/O request, e.g., whether it is a read, a write, or some other request.
LBA: the logical block address to which the I/O request is directed.
Length: the number of blocks (or bytes, kilobytes, etc.) specified by the I/O request, e.g., the number of blocks to be read for read requests or written for write requests. In an example, blocks are uniformly sized storage extents. Example block lengths are 4 kB, 8 kB, or 16 kB, but these are merely examples.

One should appreciate that the specific information collected for each I/O request may vary based on implementation. The example shown is merely an illustration.

The example I/O traces shown in FIG. 3 are intended to correspond to the read-request sequence 210 and the write-request sequence 220 shown in FIG. 2. In this example, all requests in the sequences 210 and 220 originate from the same host (Host A) and are directed to the same volume (V1). Intervening I/O requests from other hosts or to other volumes are omitted from the figure for the sake of simplicity.

In an example, the attributes generator 150 identifies read-request sequences by analyzing the I/O trace memory 140. For instance, the attributes generator 150 may monitor I/O requests in the I/O trace memory 140, looking for consecutive reads to consecutive locations of the same volume. Once it finds a read-request sequence, the attributes generator 150 may create a compact representation of that sequence and store it in the sequence data structure 160, e.g., in a manner that allows that representation to be found later based on the start LBA of the sequence, i.e., the LBA of the first read request in the sequence.

The attributes generator 150 may perform similar acts for write-request sequences, identifying them based on consecutive writes to consecutive locations of the same volume. The attributes generator 150 may likewise create a compact representation of the write sequence and store it in the sequence data structure 160, e.g., indexed by start LBA.

As an alternative to monitoring the I/O trace memory 140 for sequences, the attributes generator 150 may instead treat every read or write I/O request that is not a continuation of an existing sequence as the start of a new sequence, thereby creating a compact representation for just that one I/O request. The compact representation of the single-I/O sequence can be readily deleted from the data structure 160 if no I/O request that continues the sequence is promptly received, such as within one second.

Although the usefulness of storing read sequences is evident, i.e., so that they are available for comparisons with later-arriving write sequences, the storage of write sequences using compact representations is also advantageous. For example, write sequences may extend over time, such that it cannot be determined in real time whether a write sequence has ended. Storing compact representations of write sequences thus allows those sequences to be stored and later extended as additional write requests that continue the sequences arrive. Also, storing write sequences in the data structure 160 allows the task of matching write sequences to read sequences to be separated from the task of creating and storing compact representations. For example, a write sequence may be recorded by one task and a match may be discovered by another.

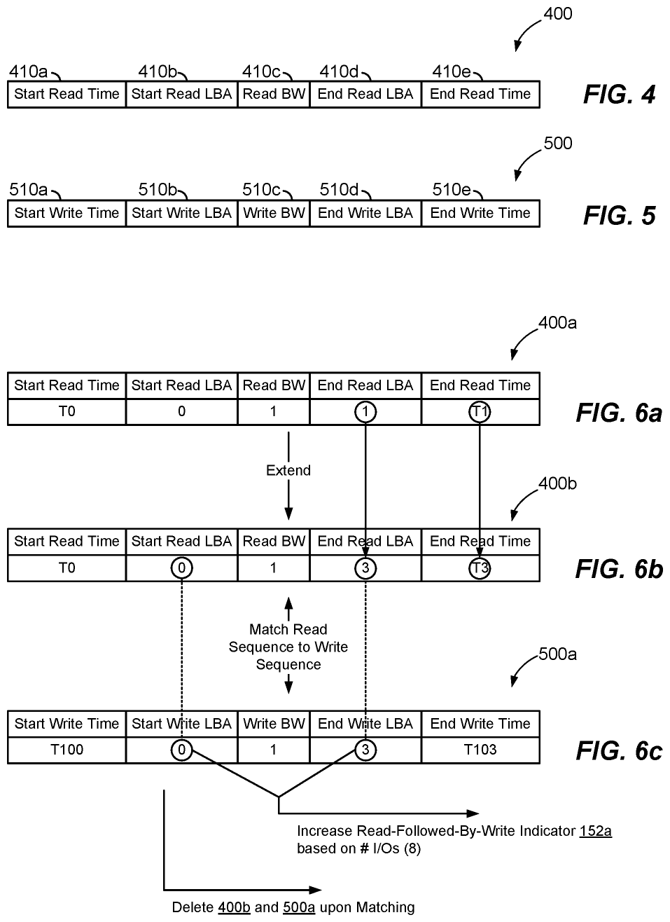

FIG. 4 shows an example compact representation 400 of a read sequence, such as the read sequence 210. Here, the compact representation 400 includes the following elements:
Start Read Time 410a: The time when the read sequence begins, e.g., the timestamp that the I/O trace memory 140 associates with the first read request in the sequence.
Start Read LBA 410b: The logical block address of the beginning of the read sequence, e.g., the LBA that the I/O trace memory 140 associates with the first read request in the sequence.
Read Bandwidth (BW) 410c: The size of individual I/O requests in the read sequence, e.g., the length that the I/O trace memory 140 associates with the read requests in the sequence.
End Read LBA 410d: The logical block address of the end of the read sequence, e.g., the LBA plus the length that the I/O trace memory 140 associates with the last read request in the sequence.
End Read Time 410e: The time when the read sequence ends, e.g., the timestamp that the I/O trace memory 140 associates with the last read request in the sequence.

One can readily see that the compact representation 400 is typically much smaller than separate representations would be of individual read requests that make up a read sequence, particularly for sequences that are longer than two or three requests.

FIG. 5 shows an example compact representation 500 of a write sequence, such as the write sequence 220. Here, the compact representation 500 includes the following elements:
Start Write Time 510a: The time when the write sequence begins, e.g., the timestamp that the I/O trace memory 140 associates with the first write request in the write sequence.
Start Write LBA 510b: The logical block address of the beginning of the write sequence, e.g., the LBA that the I/O trace memory 140 associates with the first write request in the write sequence.
Write Bandwidth (BW) 510c: The size of individual I/O requests in the write sequence, e.g., the length that the I/O trace memory 140 associates with the write requests in the write sequence.
End Write LBA 510d: The logical block address of the end of the write sequence, e.g., the LBA plus the length that the I/O trace memory 140 associates with the last write request in the write sequence.
End Write Time 510e: The time when the write sequence ends, e.g., the timestamp that the I/O trace memory 140 associates with the last write request in the write sequence.

FIGS. 6a and 6b show an example arrangement for extending a compact representation of a read-request sequence. Here, compact representation 400a may be formed from a first pair of read requests of the read sequence 210, which correspond to the first two read requests shown in FIG. 3. The compact representation 400a thus has a Start Read Time of T0, a Start Read LBA of 0, a Read BW of 1, and End Read LBA of 1, and an End Read Time of T1.

The sequence depicted in compact representation 400a may then be extended as additional read requests arrive as part of the same sequence, such as the third and fourth read requests shown in FIG. 3. For example, representation 400a may be transformed into representation 400b by updating the End Read LBA from 1 to 3 and updating the End Read Time from T1 to T3. In an example, the compact representation 400a may be found in the data structure 160 (and thereby extended) by searching for a read representation having an End Read LBA that is one less than the LBA of the third read request.

The same approach may be used for determining whether any newly arriving read request (or write request) is part of an existing sequence. For example, upon considering a new I/O request in the I/O trace memory 140, the attribute generator 150 searches the data structure 160 for a compact representation having an End LBA one less than the LBA of the new I/O request. If a compact representation is found, then the new I/O request is a continuation of a previous sequence and the compact representation of the previous sequence may be updated as described. If no compact representation is found, then the new I/O request could be the beginning of a new sequence. Accordingly, a new compact representation may be created for the new I/O request.

FIG. 6c shows an example of matching a read-request sequence, e.g., the one shown in FIG. 6B, to a later arriving write-request sequence, depicted by compact representation 500a. A match may be confirmed as follows:
Determine that the Start Write Time of the write sequence is greater than the End Read Time of the read sequence, i.e., that the write sequence follows the read sequence in time.
Determine that the Start Write LBA of the write sequence matches the Start Read LBA of the read sequence.
Determine that the End Write LBA of the write sequence matches the End Read LBA of the read sequence.

Once a match has been confirmed, the read-followed-by-write attribute 152a may be updated based on the number of I/O requests in the matching sequences (eight in this example). Also, the compact representations 400b and 500a may be deleted. Such representations can no longer be matched with any other sequences and thus serve no further purpose. Deleting them also limits the growth of the data structure 160.

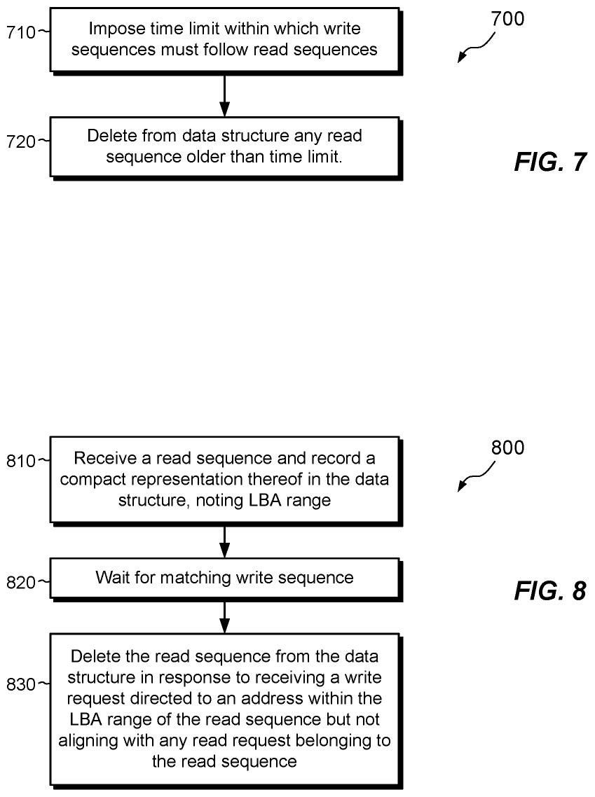

FIG. 7 shows an example method 700 of imposing a time limit within which write sequences must follow read sequences in order to be counted toward the read-followed-by-write attribute 152a. The method 700 may be performed, for example, by the attributes manager 150 running on the node 120a. At 710, a time limit is imposed within which writes must follow reads. In an example, the time limit is based on statistics of ransomware attacks, such as those shown in Tables 1 and 2 above. There, the 90th percentile gap 230 between read sequences and write sequences during ransomware attacks was found to be 22 seconds. Imposing a time limit at or above this level will ensure that most mirror I/Os are captured. In a particular example, the time limit may be set to 30 seconds; however, different time limits may be imposed for different circumstances and may change over time, e.g., for detecting new types of ransomware attacks or for use with new hardware. At 720, any compact representations of read sequences older than the time limit are deleted from the data structure 160. Method 700 thus keeps the data structure 160 from growing excessively large by deleting any representations of read sequences that are vanishingly unlikely, on account of the passage of time, to be matched with later-arriving write sequences. Compact representations of write sequences may similarly be deleted from the data structure 160 once they reach a certain age, which may be the same as the above time limit or different.

FIG. 8 shows a method 800 of further limiting the size of the data structure 160, in this case based on the receipt of an intervening write request. The method 800 may be performed, for example, by the attributes manager 150 running on the node 120a. At 810, a read-request sequence is received. A compact representation of the read-request sequence is created, and the LBA range is noted (e.g., Start Read LBA and End Read LBA). At 820, time passes while the attributes manager 150 waits to receive a matching write sequence. At 830, a new write request is received. The new write request is directed to an address within the LBA range of the read-request sequence but does not align with the beginning and length of any read request belonging to the read-request sequence. The new write request thus signals some behavior other than a mirror I/O, and the compact representation of the read-request sequence is deleted. Such deletion also limits the growth of the data structure 160.

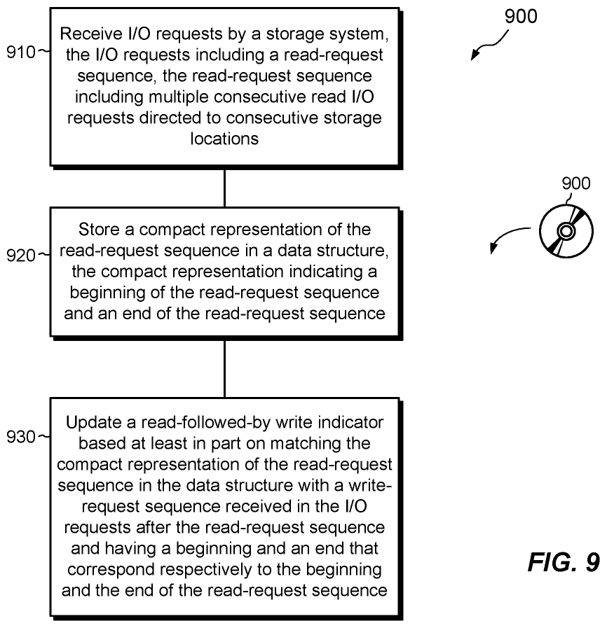

FIG. 9 shows an example method 900 of preparing a read-followed-by-write indicator and provides a summary of some of the features described above. The method 900 may be carried out in connection with the environment 100 and is typically performed, for example, by the software constructs described in connection with FIG. 1, which reside in the memory 130 of the node 120a and are run by the set of processors 124. The various acts of the method 900 may be ordered in any suitable way. Accordingly, embodiments may be constructed in which acts are performed in orders different from that illustrated, which may include performing some acts simultaneously.

At 910, I/O requests 112 are received by a storage system 116. The I/O requests 112 include a read-request sequence 210. The read-request sequence 210 includes multiple consecutive read I/O requests 112r directed to consecutive storage locations.

At 920, a compact representation 400 of the read-request sequence 210 is stored in a data structure 160. The compact representation 400 indicates a beginning of the read-request sequence (e.g., Start Read LBA 410a) and an end of the read-request sequence (e.g., End Read LBA 410d). Equivalently, a start LBA and length may be provided.

At 930, a read-followed-by write indicator 152a is updated based at least in part on matching the compact representation 400 of the read-request sequence 210 in the data structure 160 with a write-request sequence 220 received in the I/O requests 112 after the read-request sequence 210 and having a beginning (e.g., Start Write LBA 510b) and an end (e.g., End Write LBA 510d, or length) that correspond respectively to the beginning and the end of the read-request sequence 210.

An improved technique has been described of preparing a read-followed-by-write indicator 152a for detecting ransomware attacks. The technique includes tracking mirror I/Os as sequences 210 of reads 112r and sequences 220 of writes 112w. The technique includes recording compact representations 400 of read-request sequences 210 and matching at least some of the read-request sequences 210 with corresponding write-request sequences 220 that arrive later. A ransomware indicator 152a for tracking mirror I/Os may then be provided based at least in part on the matching sequences. Advantageously, the improved technique can be realized with much less memory and lesser performance impacts than the prior approach.

### Supporting Information:

The following information provides analysis results that support the embodiments described above and provide evidence for the effectiveness of tracking mirror I/O based on sequences rather than individual I/Os.

The disclosed approach was evaluated against a well-known Read/Write dataset from the RanSAP open dataset (see https://www.sciencedirect.com/science/article/pii/S2666281721002390). This dataset includes storage access patterns (i.e., I/O traces) of 7 significant ransomware samples and 5 popular benign software samples on various types and conditions of storage devices. The training dataset included 835 rows (80%), and the test dataset 209 rows (20%).

Both binary classification experiments as well as multi-class experiments were run against this dataset, using a random-forest classification algorithm. We had an initial concern that this experiment would not capture the class imbalance between benign and ransomware. We therefore ran a 2nd set of experiments where we injected additional benign samples in order to reflect more realistically the class imbalance (with a 5:1 ratio between the benign and malware class), and again ran both binary classification experiments as well as multi-class experiments.

Model results for binary classification are shown in Table 3 below, and model results for multi-class experiments are shown in Table 4.

TABLE 3
Model results for binary classification
Metrics:

| | |
|---|---|
| Precision | 1 |
| Recall | 1 |
| F1-Score | 1 |
| Accuracy | 1 |

TABLE 4
Model results for multi-class classification
Metrics:

| | |
|---|---|
| Precision | 0.98 |
| Recall | 0.98 |
| F1-Score | 0.98 |
| Accuracy | 0.98 |

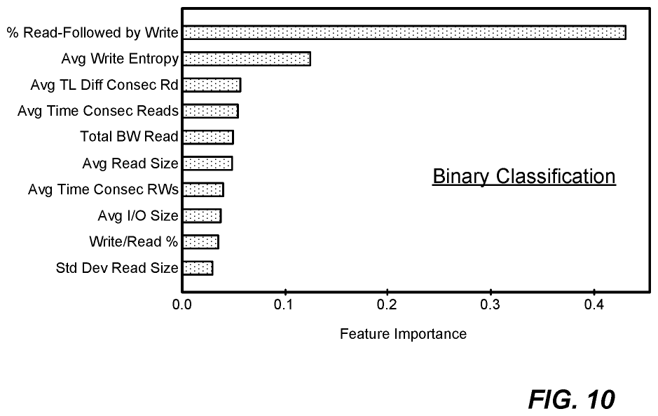

FIG. 10 shows various ransomware attributes 152 and their relative importance in detecting ransomware. The results are provided for binary classification (ransomware or benign) using the RanSAP dataset. The particular read-followed-by-write attribute shown in FIG. 10 is based on individual mirror I/Os, i.e., individual reads followed by individual writes to the same locations. It is not based on sequences.

It can be seen from FIG. 10 that the most important attribute by far is the read-followed-by-write attribute. Indeed, read-followed-by-write is more than three times as important as the next most important attribute (average write entropy).

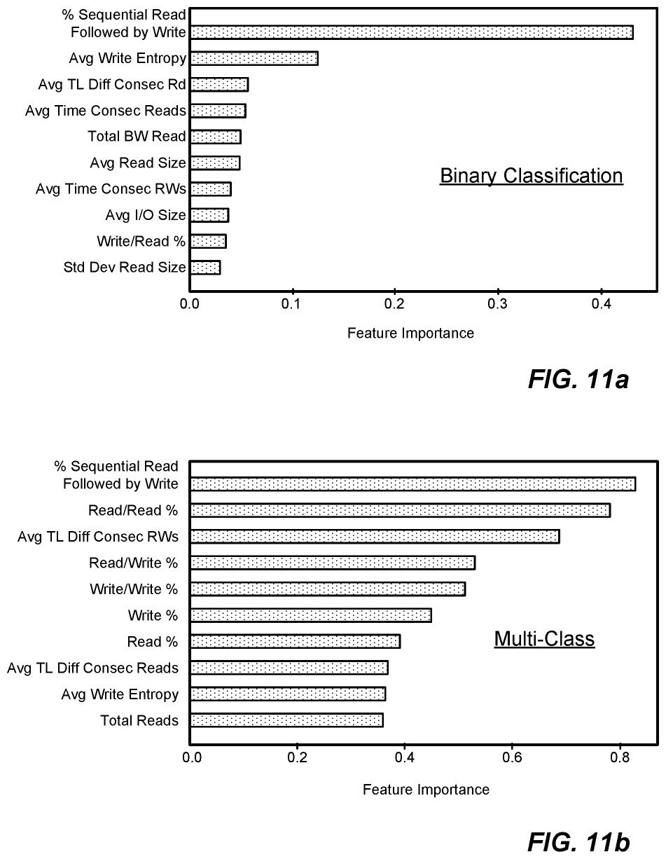

Turning now to FIG. 11a, one sees very similar results when the read-followed-by-write attribute of FIG. 10 is replaced with a sequential read-followed-by-write attribute 152a, like the one described in the above embodiments. The importance of the sequential read-followed-by-write attribute 152a is nearly identical to that of the mirror I/O attribute based on individual reads and writes shown in FIG. 10.

FIG. 11b is similar to FIG. 11a, but here multiple classifications are used for respective types of ransomware. Once again, the sequential read-followed-by-write attribute 152a is the most important.

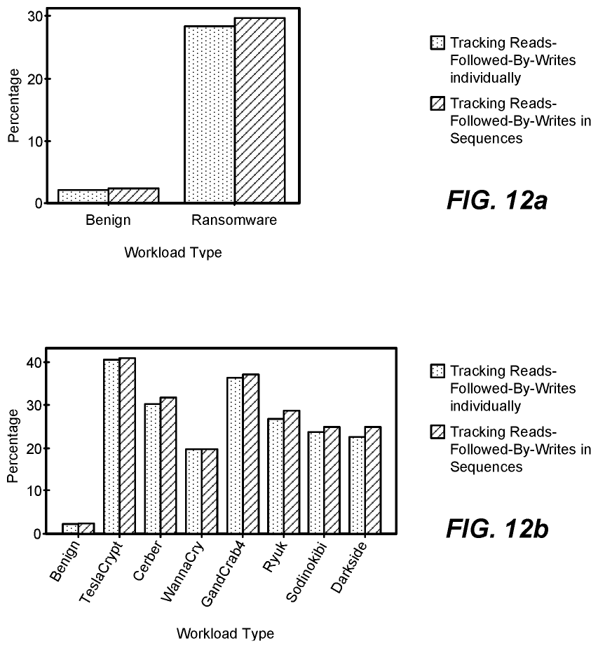

FIGS. 12a and 12b compares the original and compact (sequential) mirror I/Os features in terms of their likelihood in the benign vs. ransomware classes (FIG. 12a) and also for the 7 specific ransomware variants (FIG. 12b). One can see that the distribution is very close.

Finally, the storage space needed for the full mirror I/O feature in our experimental setup was 4.938 GB, and for the compact (sequential) mirror I/O feature it was 0.166 GB, reflecting a memory saving of 96.64%! All of these results confirm our claim that the compact representation captures the full benefit of the original “verbose” feature, at a fraction of the cost.

Having described certain embodiments, numerous alternative embodiments or variations can be made. For example, although the embodiments described above provide a read-followed-by-write attribute 152a for use in ransomware detection, this is merely an example. Other embodiments may use the read-followed-by-write attribute 152a for other purposes, such as for tracking system I/O performance.

Further, although embodiments have been described that involve one or more data storage systems, other embodiments may involve computers, including those not normally regarded as data storage systems. Such computers may include servers, such as those used in data centers and enterprises, as well as general purpose computers, personal computers, and numerous devices, such as smart phones, tablet computers, personal data assistants, and the like.

Further, although features have been shown and described with reference to particular embodiments hereof, such features may be included and hereby are included in any of the disclosed embodiments and their variants. Thus, it is understood that features disclosed in connection with any embodiment are included in any other embodiment.

Further still, the improvement or portions thereof may be embodied as a computer program product including one or more non-transient, computer-readable storage media, such as a magnetic disk, magnetic tape, compact disk, DVD, optical disk, flash drive, solid state drive, SD (Secure Digital) chip or device, Application Specific Integrated Circuit (ASIC), Field Programmable Gate Array (FPGA), and/or the like (shown by way of example as medium 950 in FIG. 9). Any number of computer-readable media may be used. The media may be encoded with instructions which, when executed on one or more computers or other processors, perform the process or processes described herein. Such media may be considered articles of manufacture or machines, and may be transportable from one machine to another.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Also, a “set of” elements can describe fewer than all elements present. Thus, there may be additional elements of the same kind that are not part of the set. Further, ordinal expressions, such as “first,” “second,” “third,” and so on, may be used as adjectives herein for identification purposes. Unless specifically indicated, these ordinal expressions are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Also, and unless specifically stated to the contrary, “based on” is intended to be nonexclusive. Thus, “based on” should be interpreted as meaning “based at least in part on” unless specifically indicated otherwise. Although certain embodiments are disclosed herein, it is understood that these are provided by way of example only and should not be construed as limiting.

Those skilled in the art will therefore understand that various changes in form and detail may be made to the embodiments disclosed herein without departing from the scope of the following claims.

What is claimed is:

1. A method of preparing a read-followed-by-write indicator for detecting suspected ransomware attacks in a storage system, comprising:
receiving I/O requests by the storage system, the I/O requests including a read-request sequence, the read-request sequence including multiple consecutive read I/O requests directed to consecutive storage locations;
storing a compact representation of the read-request sequence in a data structure, the compact representation indicating a beginning of the read-request sequence and an end of the read-request sequence; and
updating the read-followed-by write indicator based at least in part on matching the compact representation of the read-request sequence in the data structure with a write-request sequence received in the I/O requests after the read-request sequence and having a beginning and an end that correspond respectively to the beginning and the end of the read-request sequence.

2. The method of claim 1, wherein updating the read-followed-by write indicator includes increasing the read-followed-by write indicator based on a number of read requests in the read-request sequence.

3. The method of claim 2, wherein the read-request sequence has a length, wherein the compact representation of the read-request sequence further indicates an I/O size of I/O requests that belong to the read-request sequence, and wherein updating the read-followed-by write indicator further includes determining, based on the length of the read-request sequence and the indicated I/O size, the number of read requests in the read-request sequence.

4. The method of claim 1, further comprising deleting the compact representation of the read-request sequence from the data structure in response to said matching.

5. The method of claim 4, further comprising:
prior to matching, storing in the data structure a compact representation of the write-request sequence; and
deleting the compact representation of the write-request sequence from the data structure in response to said matching.

6. The method of claim 1, further comprising imposing a time limit within which write-request sequences must follow corresponding read-request sequences to be counted toward the read-followed-by write indicator.

7. The method of claim 6, wherein the I/O requests include a second read-request sequence, and wherein the method further comprises:
storing a compact representation of the second read-request sequence in the data structure; and
subsequently deleting the compact representation of the second read-request sequence from the data structure in response to no corresponding write-request sequence being received within the defined time limit.

8. The method of claim 1, wherein the I/O requests include a third read-request sequence, and wherein the method further comprises:
storing a compact representation of the third read-request sequence in the data structure, the compact representation of the third read-request sequence identifying a beginning and an end of the third read-request sequence;
subsequently deleting the compact representation of the third read-request sequence from the data structure in response receipt of a write request directed to a location that falls between the beginning and the end of the third read-request sequence but does not correspond in location with any individual read request in the third read-request sequence.

9. The method of claim 1, wherein the I/O requests include a fourth read-request sequence and a fifth read-request sequence received after the fourth read-request sequence, and wherein the method further comprises:
storing a compact representation of the fourth read-request sequence in the data structure; and
after receipt of the fifth read-request sequence, (i) determining that the fifth read-request sequence is a continuation of the fourth read-request sequence and (ii) merging the fifth read-request sequence into the fourth read-request sequence.

10. The method of claim 1, further comprising:
capturing respective traces of the I/O requests in a trace memory; and
identifying the read-request sequence by analyzing the trace memory,
wherein storing the compact representation of the read-request sequence is responsive to identifying the read-request sequence from the trace memory.

11. A computerized apparatus, comprising control circuitry that includes a set of processors coupled to memory, the control circuitry constructed and arranged to:
receive I/O requests by the storage system, the I/O requests including a read-request sequence, the read-request sequence including multiple consecutive read I/O requests directed to consecutive storage locations;
store a compact representation of the read-request sequence in a data structure, the compact representation indicating a beginning of the read-request sequence and an end of the read-request sequence; and
update the read-followed-by write indicator based at least in part on matching the compact representation of the read-request sequence in the data structure with a write-request sequence received in the I/O requests after the read-request sequence and having a beginning and an end that correspond respectively to the beginning and the end of the read-request sequence.

12. A computer program product including a set of non-transitory, computer-readable media having instructions which, when executed by control circuitry of a computerized apparatus, cause the computerized apparatus to perform a method of preparing a read-followed-by-write indicator, the method comprising:
receiving I/O requests by the storage system, the I/O requests including a read-request sequence, the read-request sequence including multiple consecutive read I/O requests directed to consecutive storage locations;
storing a compact representation of the read-request sequence in a data structure, the compact representation indicating a beginning of the read-request sequence and an end of the read-request sequence; and
updating the read-followed-by write indicator based at least in part on matching the compact representation of the read-request sequence in the data structure with a write-request sequence received in the I/O requests after the read-request sequence and having a beginning and an end that correspond respectively to the beginning and the end of the read-request sequence.

13. The computer program product of claim 12, wherein updating the read-followed-by write indicator includes increasing the read-followed-by write indicator based on a number of read requests in the read-request sequence.

14. The computer program product of claim 13, wherein the read-request sequence has a length, wherein the compact representation of the read-request sequence further indicates an I/O size of I/O requests that belong to the read-request sequence, and wherein updating the read-followed-by write indicator further includes determining, based on the length of the read-request sequence and the indicated I/O size, the number of read requests in the read-request sequence.

15. The computer program product of claim 12, wherein the method further comprises deleting the compact representation of the read-request sequence from the data structure in response to said matching.

16. The computer program product of claim 15, wherein the method further comprises:
prior to matching, storing in the data structure a compact representation of the write-request sequence; and
deleting the compact representation of the write-request sequence from the data structure in response to said matching.

17. The computer program product of claim 12, wherein the method further comprises imposing a time limit within which write-request sequences must follow corresponding read-request sequences to be counted toward the read-followed-by write indicator.

18. The computer program product of claim 17, wherein the I/O requests include a second read-request sequence, and wherein the method further comprises:
storing a compact representation of the second read-request sequence in the data structure; and
subsequently deleting the compact representation of the second read-request sequence from the data structure in response to no corresponding write-request sequence being received within the defined time limit.

19. The computer program product of claim 12, wherein the I/O requests include a third read-request sequence, and wherein the method further comprises:
storing a compact representation of the third read-request sequence in the data structure, the compact representation of the third read-request sequence identifying a beginning and an end of the third read-request sequence;
subsequently deleting the compact representation of the third read-request sequence from the data structure in response receipt of a write request directed to a location that falls between the beginning and the end of the third read-request sequence but does not correspond in location with any individual read request in the third read-request sequence.

20. The computer program product of claim 12, wherein the I/O requests include a fourth read-request sequence and a fifth read-request sequence received after the fourth read-request sequence, and wherein the method further comprises:
storing a compact representation of the fourth read-request sequence in the data structure; and
after receipt of the fifth read-request sequence, (i) determining that the fifth read-request sequence is a continuation of the fourth read-request sequence and (ii) merging the fifth read-request sequence into the fourth read-request sequence.
